(19) United States
(12) Patent Application Publication
(10) Pub. No.: US 2025/0322194 A1
(43) Pub. Date: Oct. 16, 2025

(54) PRINTER AND NON-TRANSITORY COMPUTER-READABLE STORAGE MEDIUM

(71) Applicant: BROTHER KOGYO KABUSHIKI KAISHA, Nagoya (JP)

(72) Inventors: Kazuhide SAWADA, Nagoya (JP); Masayoshi FUJII, Okazaki (JP)

(21) Appl. No.: 19/179,841

(22) Filed: Apr. 15, 2025

(30) Foreign Application Priority Data
Apr. 16, 2024 (JP) 2024-066104
Apr. 16, 2024 (JP) 2024-066106

(51) Int. Cl. G06K 15/02; G06V 30/14; H04N 1/40

(52) U.S. Cl. CPC G06K 15/1847; G06V 30/14; H04N 1/40012

(57) ABSTRACT

A printer generates intermediate data that is a multivalued image based on image data to be printed, and converts the generated intermediate data into two gray scales by dither processing or the like to generate a binarized image. Further, the printer causes a printing device to execute printing based on the generated binarized image. The printer detects character data from the image data before generating the intermediate data, adds a broken line to an edge of the character represented by the character data when a size of the character represented by the detected character data is a predetermined size or more, and generates intermediate data based on the character to which the broken line is added. The printer does not add a broken line when the size of the character represented by the character data is less than the predetermined size.

### REFERENCE TO RELATED APPLICATIONS

This application claims priority from Japanese Patent Applications No. 2024-066104 filed on Apr. 16, 2024, and No. 2024-066106 filed on Apr. 16, 2024. The entire contents of these priority applications are incorporated herein by reference.

### BACKGROUND ART

In a related art, in a printer, a technique in which an image configured with multiple values is converted into two gray scales by dither processing or error diffusion processing to form a binarized image to express the light and shade is known. In this binarized image, as the density decreases, the proportion of a portion including no dots increases. Therefore, during printing based on the binarized image, a portion where dots are largely chipped may be exposed to an edge, and so-called jaggies are likely to occur. Accordingly, as disclosed in Patent Literature 1, a method for making the edge appear smoothly is proposed.

When edge enhancement processing is executed on a character in a binarized image to make an edge appear smoothly as in the related art, jaggies are less likely to occur, but another problem occurs that the character may appear to be edged.

### SUMMARY

In order to solve this problem, there is provided a printer including: a printing device: and a controller, in which the controller is capable of executing acquisition processing of acquiring image data, multivalued image generation processing of generating a multivalued image configured with multiple values based on the image data acquired in the acquisition processing, binarization processing of converting the multivalued image generated in the multivalued image generation processing into two gray scales to generate a binarized image, and printing processing of causing the printing device to execute printing based on the binarized image generated in the binarization processing, the controller is further configured to execute character detection processing of detecting character data representing a character from the image data acquired in the acquisition processing before executing the multivalued image generation processing and after executing the acquisition processing, when a size of the character represented by the character data detected in the character detection processing is a predetermined size or more, to execute broken line addition processing of adding a broken line to an edge of the character represented by the character data detected in the character detection processing and to generate the multivalued image in the multivalued image generation processing based on the character to which the broken line is added in the broken line addition processing, and when the size of the character represented by the character data detected in the character detection processing is less than the predetermined size, not to execute the broken line addition processing.

In the printer disclosed in the present specification, a broken line is added to the edge of the character in the image to be printed before generating the multivalued image. Therefore, it can be expected that the broken line covers a part of large chipping exposed to the edge of the binarized character. As a result, the chipping of the edge of the character is inconspicuous, and the occurrence of jaggies is suppressed. Note that, when the size of the character is small, chipping is less likely to occur in the edge of the character, and by adding a broken line, the broken line is conspicuous, which may rather deteriorate the quality. The printer does not add a broken line to a small character. Therefore, the deterioration of the quality can be reduced.

A printing system including the above-described printer, a control method for implementing the function of the printer, a computer program, and a computer-readable storage medium storing the program are novel and useful.

According to the technique disclosed in the present specification, it is possible to implement a technique of improving the image quality of a character when an image configured with multiple values is converted into two gray scales for printing.

### BRIEF DESCRIPTION OF DRAWINGS

FIG. 1 is a block diagram illustrating a schematic configuration of a printer.

FIG. 2 is a flowchart illustrating a procedure of printing job processing.

FIG. 3 is a flowchart illustrating a procedure of character intermediate data generation processing.

FIG. 4 is a diagram illustrating an example of a text drawing command in a PDF format.

FIG. 5 is a flowchart illustrating a procedure of density adjustment processing.

FIG. 6 is a flowchart illustrating a procedure of broken line type determination processing.

FIG. 7 is a diagram illustrating an example of a relationship between a character density and a broken line type.

FIGS. 8A to 8C are diagrams illustrating an example of a part of intermediate data to which a broken line is added.

FIGS. 9A to 9C are diagrams illustrating an example where a printing resolution is a low resolution.

FIGS. 10A to 10E are diagrams illustrating an example of a character having a thin line and a low character density.

FIGS. 11A to 11C are diagrams illustrating an example of a character having a low character size.

FIGS. 12A to 12C are diagrams illustrating an example of a part of binarized data to which a broken line is added.

FIG. 13 is a block diagram illustrating a schematic configuration of a PC connected to the printer.

FIG. 14 is a flowchart illustrating a procedure of printing job processing to be executed by the PC.

### DESCRIPTION

Hereinafter, a printer according to an embodiment will be described in detail with reference to the accompanying drawings. The present embodiment discloses a printer capable of printing based on a color image configured with multiple values.

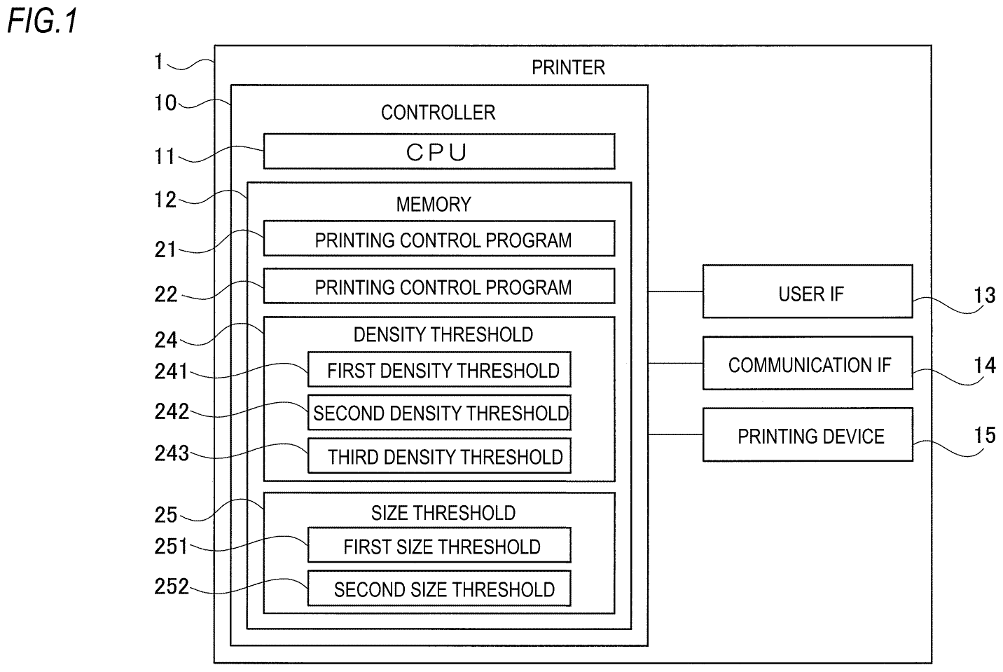

As illustrated in FIG. 1, a printer 1 includes a controller 10 including a CPU 11 and a memory 12. In addition, the printer 1 includes a user interface (hereinafter, referred to as “user IF”) 13, a communication interface (hereinafter, referred to as “communication IF”) 14, and a printing device 15. All of the user IF 13, the communication IF 14, and the printing device 15 are electrically connected to the controller 10. The controller 10 in FIG. 1 is a generic name for both of hardware and software used for controlling a printer 1, and does not necessarily represent single hardware that is actually present in the printer 1.

The CPU 11 executes various processing in accordance with a program read from the memory 12 or based on an operation of a user. The memory 12 stores various programs or various data. As illustrated in FIG. 1, the memory 12 stores, for example, a printing control program 21, a binarization program 22, a density threshold 24, and a size threshold 25. Various values in the density threshold 24 or the size threshold 25 may be incorporated into the printing control program 21 in advance, or may be acquired from a server or the like and stored in the memory 12. The details of programs or data stored in the memory 12 will be described below. The memory 12 is used as a work area where various processing is executed. The memory 12 may include a buffer in the CPU 11.

An example of the memory 12 is not limited to a ROM, a RAM, an HDD, or the like built in the printer 1, and may be a storage medium that is readable and writable by the CPU 11. The computer-readable storage medium is a non-transitory medium. Examples of the non-transitory medium include a CD-ROM and a DVD-ROM in addition to the above-described examples. In addition, the non-transitory medium is also a tangible medium. On the other hand, an electrical signal for conveying a program downloaded from a server on the Internet is a computer-readable signal medium that is one type of computer-readable medium, but is not a non-transitory computer-readable storage medium.

The user IF 13 includes hardware that displays a screen for notifying information to a user and hardware that receives an operation of the user. The user IF 13 may include a touch panel or may include a combination of a display unit and an operation button.

The communication IF 14 includes hardware for communication with an external device. The communication standard of the communication IF 14 is Ethernet (registered trademark), Wi-Fi (registered trademark), USB, or the like. The printer 1 may include a plurality of communication IFs 14 supporting a plurality of communication standards.

The printing device 15 includes a device capable of executing printing based on image data using, for example, an electrophotographic method or an ink jet method. The printing device 15 of the printer 1 according to the present embodiment is a device including colorants of a plurality of colors and capable of executing color printing.

Next, an operation of the printer 1 according to the embodiment will be described with reference to a flowchart. The following processing basically represents processing of the CPU 11 in accordance with commands described in the program. That is, in the following description, processing such as “determining”, “extracting”, “selecting”, “calculating”, “determining”, “identifying”, “acquiring”, “receiving”, or “controlling” represents the processing of the CPU 11. The processing of the CPU 11 also includes a hardware control using an API of an operating system (hereinafter, referred to as “OS”). In the present specification, an operation of each of programs will be described while omitting the description of the OS. That is, in the following description, the description “a program B controls hardware C” may represent “the program B controls the hardware C using the API of the OS”. In addition, the processing of the CPU 11 in accordance with a command described in the program will also be described with some words omitted. For example, it is assumed that there is a description “the CPU 11 executes”. In addition, the processing of the CPU 11 in accordance with a command described in the program will also be described as “a program A executes” where the CPU is omitted.

“Acquisition” is used as a concept that does not require a request. That is, processing of receiving data without a request from the CPU 11 is also included in a concept “the CPU acquires data”. In addition, “data” in the present specification is represented by a computer-readable bit string. Data with substantially the same content but different formats will be treated as the same data. The same applies to “information” in the present specification. In addition, “request” or “instruct” is a concept of outputting information representing a request or information representing an instruction to an opponent. In addition, the information representing a request or the information representing an instruction will also be simply described as “request” or “instruction”.

In addition, processing of the CPU 11 determining whether information A is a matter B will be conceptually described as “determining whether a matter B occurs based on information A”. In addition, processing of the CPU 11 determining whether information A is a matter B or a matter C will be conceptually described as “determining whether a matter B or a matter C occurs based on information A”.

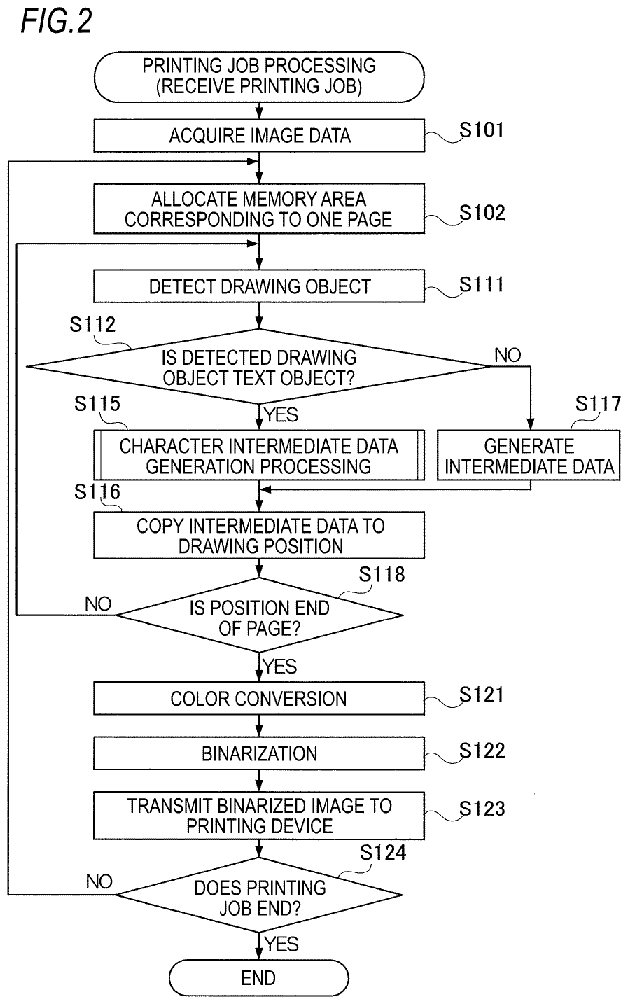

A procedure of printing job processing will be described with reference to a flowchart of FIG. 2. In response to receiving an instruction to execute a printing job, the printing job processing is executed by the CPU 11 of the printer 1 based on the printing control program 21. The printer 1 may receive and acquire the printing job from an external device through the communication IF 14, or may read and acquire from an USB memory attached to the communication IF 14. In addition, when the printer 1 includes a scanner, the printer 1 may acquire image data read from the scanner as the printing job.

The CPU 11 starts analyzing the printing job that is instructed to be executed, and acquires image data representing an image to be printed (S101). S101 is an example of acquisition processing. The printing job includes, for example, PDL data that is the image data representing the image to be printed and PJL data representing various parameters regarding printing. The PDL data is, for example, data in a format such as PCL or PDF. Further, the CPU 11 allocates a memory area for writing an image corresponding to one page (S102).

The CPU 11 detects a drawing object from the image data representing the image to be printed in the printing job (S111). The CPU 11 analyzes the PDL data to determine whether the image is the drawing object. When the drawing object is detected, the CPU 11 determines whether the detected drawing object is a text object representing drawing of a character (S112). S112 is an example of character detection processing.

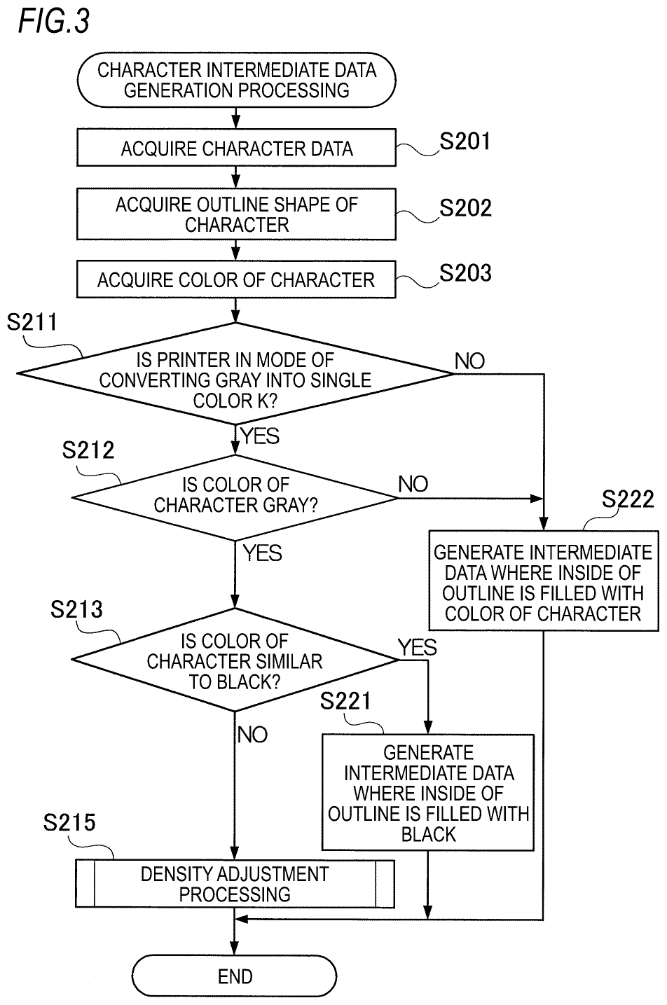

When the detected drawing object is determined as the text object (S112: YES), the CPU 11 executes character intermediate data generation processing (S115). A procedure of the character intermediate data generation processing will be described with reference to a flowchart of FIG. 3.

In the character intermediate data generation processing, the CPU 11 acquires character data that is various information regarding a character represented by the text object to be processed (S201). Specifically, the CPU 11 acquires character data including font information designated by the text object to be processed and a character code representing a character type. The font information includes, for example, a font type, a character size, a color of the character, and a character density. The character size is information representing the size of the font to be used and corresponds to the size of the character, and the character density corresponds to the density of the character.

Further, the CPU 11 acquires data representing an outline shape of each of characters in the text object based on the character data (S202). The data representing the outline shape of the character may be stored in the memory 12 of the printer 1 or may be embedded in the printing job. The outline shape of the character is also information representing a position of an edge of the character.

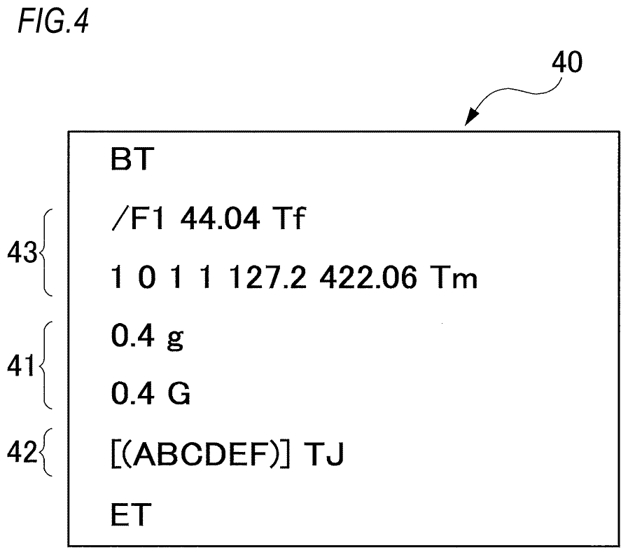

Further, the CPU 11 acquires information representing a color of the character from the character data acquired in S201 (S203). For example, as illustrated in FIG. 4, image data 40 in the PDF format may include density information 41, a text drawing command 42, and font information 43. In the image data 40 of this example, a color of a character string “ABCDEF” designated by the text drawing command 42 is designated by “g” or “G” of the density information 41. The density information 41 of the example represents gray characters having a density of 40%. The font information 43 includes information representing a font type and a character size.

When the gray character is printed by color printing, the CPU 11 determines whether the printer 1 is in a mode of printing using only a colorant of the color K (S211). The printer 1 includes, for example, colorants of four colors CMYK and, when printing based on a multivalued color image represented by RGB data is executed, can convert color information into color information represented by each of the colors CMYK for printing. The printer 1 includes, for example, a character mode and a photography mode as the printing mode, and can set any one of the modes. The printer 1 stores information representing the set printing mode in the memory 12, for example, based on selection of the user. The printer 1 may designate the mode by receiving an instruction from a printer driver that transmits the printing job.

When the character mode is set, the printer 1 converts the color information in a gray position of the image to be printed into color information represented by only the color K, and executes printing using only the colorant of the color K. The character mode is an example of a mode for printing the gray character in the color image using the black colorant, and is an example of a first mode. When the photography mode is set, the printer 1 converts the color information in the gray position of the image to be printed into color information represented by each of the colors CMYK, and executes printing using the colorants of the plurality of colors other than the color K. When the photography mode is set, the printer 1 may convert the color information in the gray position of the image to be printed into color information represented by each of the colors CMY, and may execute printing using the colorants of the plurality of colors not including the color K. The photography mode is an example of a mode for printing the gray character in the color image using the plurality of colorants, and is an example of a second mode. Regarding an image or a character that is not gray, in any of the modes, the printer 1 converts the color information into color information represented by each of the colors CMYK or CMY, and executes printing using the colorants of the plurality of colors.

When the CPU 11 determines that the mode of printing using only the colorant of the color K is selected (S211: YES), the CPU 11 determines whether a color of a character to be processed is gray (S212). For example, in a case where the color of the character is represented by RGB data where each of the R value, the G value, and the B value is in a range of 0 to 255, when all of the R value, the G value, and the B value are 0, the color is black. In addition, when all of the R value, the G value, and the B value are not 0 and are the same, the color is gray. In S212, when the R value, the G value, and the B value are very close to each other, for example, when a difference between a maximum value and a minimum value among the values is within 5, the CPU 11 may determine that the color is gray.

When the CPU 11 determines that the color of the character to be processed is gray (S212: YES), the CPU 11 determines whether the color of the character is similar to black (S213). When an average value of the R value, the G value, and the B value is a predetermined threshold or less, for example, 51 or less, the CPU 11 may determine that the color is similar to black. Since the CPU 11 determines that the color is gray in S212, the R value, the G value, and the B value are very similar to close to each other. Instead of calculating the average value, the CPU 11 may determine that the color similar to black when at least one of the R value, the G value, and the B value is 51 or less.

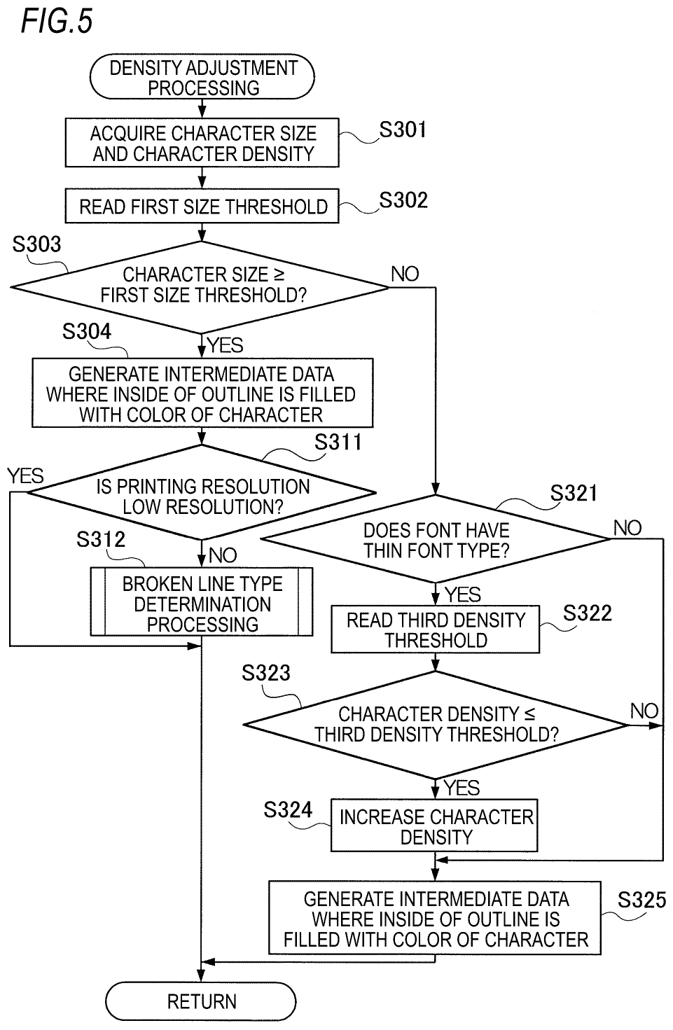

When the color of the character is not similar to black (S213: NO), the CPU 11 executes density adjustment processing (S215). A procedure of the density adjustment processing will be described with reference to a flowchart of FIG. 5.

In the density adjustment processing, the CPU 11 acquires a character size and a character density regarding the character to be processed (S301). Information regarding the character size and the character density is included in the character data acquired in S201 of the character intermediate data generation processing. For example, in the image data 40 in the PDF format illustrated in FIG. 4, the information regarding the character size is included in the font information 43, and the information regarding the character density is included in the density information 41.

Further, the CPU 11 reads a first size threshold 251 in the size threshold 25 (refer to FIG. 1) from the memory 12 (S302). The first size threshold 251 is an example of a predetermined size. The CPU 11 determines whether the character size acquired in S301 is more than or equal to the first size threshold 251 read in S302 (S303). The first size threshold 251 is, for example, 7 point.

When the CPU 11 determines that the character size is the first size threshold 251 or more (S303: YES), the CPU 11 fills the inside of the outline shape of the character acquired in S202 of the character intermediate data generation processing (refer to FIG. 3) with the color of the character acquired in S203, and generates intermediate data that is multivalued bitmap data (S304).

The intermediate data is, for example, RGB data representing a color using a gray scale value of each of the colors RGB per pixel. When the image data in the printing job is not RGB data, the CPU 11 may convert the data into RGB data to generate intermediate data. The CPU 11 stores the generated intermediate data in a temporary area of the memory 12. In the case of a text object representing a character string including a plurality of characters, the CPU 11 generates intermediate data for each of the characters, and stores the intermediate data of each of the characters in the temporary area of the memory 12.

Further, the CPU 11 determines whether a printing resolution is a low resolution (S311). Information regarding the printing resolution is included in, for example, a printing setting of the printing job. When the printing resolution is lower than a predetermined resolution, the CPU 11 determines that the printing resolution is a low resolution. The predetermined resolution is, for example, 600 dpi. In this case, for example, when the printing resolution is 300 dpi, the CPU 11 determines that the printing resolution is a low resolution. When the printing resolution is not included in the printing setting of the printing job, the CPU 11 may acquire a default printing resolution set in the printer 1 for the determination.

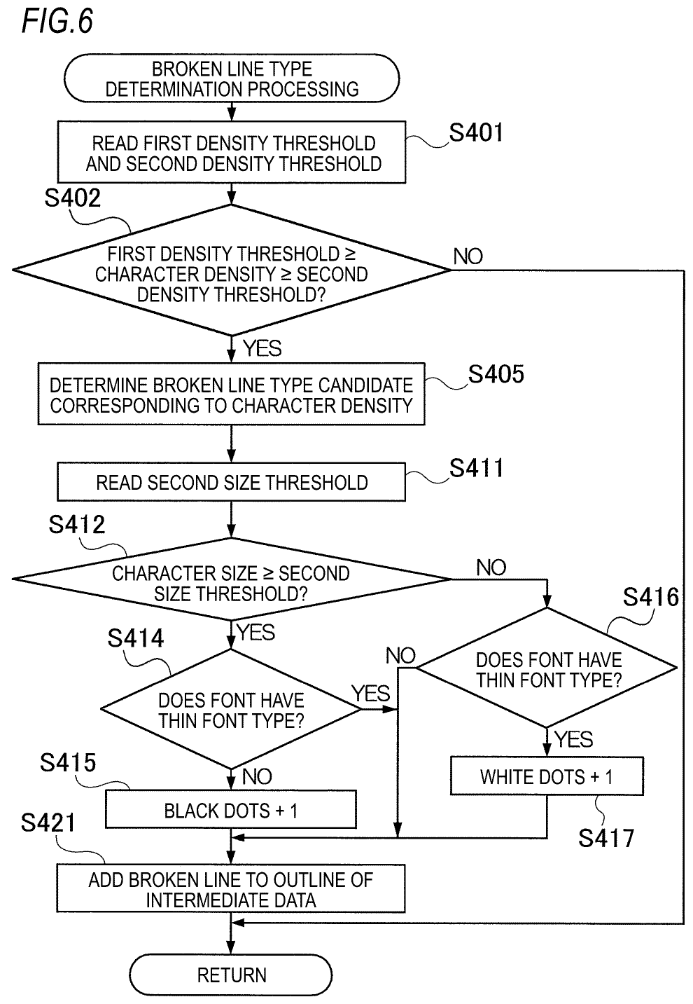

When the CPU 11 determines that the printing resolution is the predetermined resolution or higher and is not a low resolution (S311: NO), the CPU 11 executes broken line type determination processing (S312). A procedure of the broken line type determination processing will be described with reference to a flowchart of FIG. 6.

In the printer 1 according to the present embodiment, a broken line may be added along data representing the outline shape of the character of the generated intermediate data. The broken line to be added is a broken line having a line width of one dot where one or more dots having a density of 100% and one or more dots having a density of 0% are alternately disposed. The dot having a density of 100% is a dot where all of the R value, the G value, and the B value are 0, which will be referred to as “black dot” below. The dot having a density of 0% is a dot where all of the R value, the G value, and the B value are the highest value, which will be referred to as “white dot” below.

In the broken line type determination processing, the CPU 11 determines a type of the broken line to be added. First, the CPU 11 reads a first density threshold 241 and a second density threshold 242 in the density threshold 24 (refer to FIG. 1) from the memory 12 (S401). The first density threshold 241 is an example of a first threshold. The second density threshold 242 is an example of a second threshold.

The first density threshold 241 is higher than 70% and is, for example, preferably in a range of 70% to 95% and more preferably in a range of 85% to 95%. The first density threshold 241 is, for example. 90%. In addition, the second density threshold 242 is lower than the first density threshold 241, is lower than 60%, and is preferably in a range of 35% to 60% and more preferably in a range of 35% to 45%. The second density threshold 242 is, for example, 40%. The second density threshold 242 may be lower than the first density threshold 241. However, when the second density threshold 242 is excessively lower than the first density threshold 241, the effect of jaggies is small, but the processing load increases.

The CPU 11 determines whether the character density acquired in S301 of the density adjustment processing (refer to FIG. 5) is the first density threshold 241 or less and the second density threshold 242 or more (S402). The determination of S402 may be made except when the character density and each of the density thresholds in the density threshold 24 are the same. When the CPU 11 determines that the character density is the first density threshold 241 or less and the second density threshold 242 or more (S402: YES), the CPU 11 determines broken line type candidates corresponding to the character density (S405).

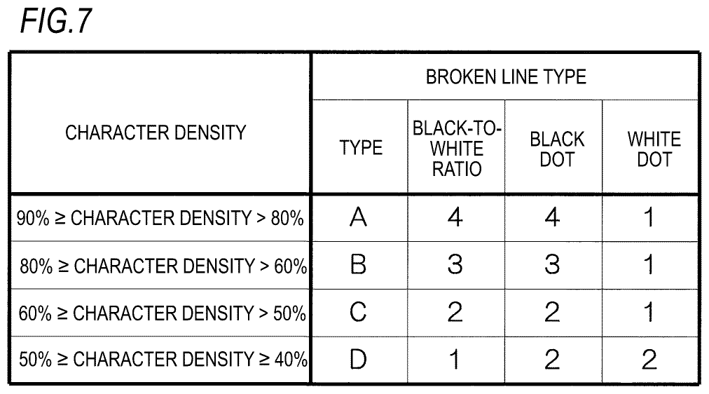

Specifically, for example, as illustrated in FIG. 7, the CPU 11 determines a broken line type having a higher black-to-white ratio for a higher character density as a broken line type candidate based on the character density. The black-to-white ratio of the broken line is a ratio of the length of line segments to the length of non-line segments in a length direction of the broken line. The line segment is a segment that is formed by consecutive black dots in the broken line. The non-line segment is a segment that is disposed between one line segment and another line segment and is formed by consecutive white dots.

The length of the line segment is a result of multiplying the number of consecutive black dots by the size of the dots (length in the line direction), and is proportional to the number of the consecutive black dots. The length of the non-line segment is a result of multiplying the number of consecutive white dots by the size of the dots, and is proportional to the number of the consecutive white dots. The size of each of the dots in one image does not change between the black dot and the white dot. That is, the black-to-white ratio of the broken line can be represented by a ratio of the number of consecutive black dots forming the line segments to the number of consecutive white dots forming the non-line segments. For example, when n represents a natural number, a black-to-white ratio of the broken line where n black dots and one white dot are alternately disposed is n. It can be said that the length of the line segment corresponds to the number of consecutive black dots, and the length of the non-line segment corresponds to the number of consecutive white dots.

When the character density is 90% or less and more than 80%, the CPU 11 sets a broken line of a type A having a black-to-white ratio of 4 as a broken line type candidate. The broken line of the type A is, for example, a broken line where a line segment of four black dots and a non-line segment of one white dot are alternately arranged. When the character density is 80% or less and more than 60%, the CPU 11 sets a broken line of a type B having a black-to-white ratio of 3 as a broken line type candidate. The broken line of the type B is, for example, a broken line where a line segment of three black dots and a non-line segment of one white dot are alternately arranged. When the character density is 60% or less and more than 50%, the CPU 11 sets a broken line of a type C having a black-to-white ratio of 2 as a broken line type candidate. The broken line of the type C is, for example, a broken line where a line segment of two black dots and a non-line segment of one white dot are alternately arranged. When the character density is 50% or less and 40% or more, the CPU 11 sets a broken line of a type D having a black-to-white ratio of 1 as a broken line type candidate. The broken line of the type D is, for example, a broken line where a line segment of two black dots and a non-line segment of two white dots are alternately arranged.

That is, when the character density is the first density, the CPU 11 sets, as a broken line type candidate, a broken line type having a lower black-to-white ratio than that at a second density higher than the first density. For example, when the character density is 50%, the CPU 11 sets a broken line type having a black-to-white ratio of 1 as a broken line type candidate, and when the character density is 90%, sets a broken line type having a black-to-white ratio of 4 as a broken line type candidate. 50% is an example of the first density, and 90% is an example of the second density. The number of broken lines having the same black-to-white ratio or the number of broken lines having different lengths of the non-line segments is countless, but the CPU 11 sets a broken line where the number of consecutive white dots is 3 or less as a broken line type candidate.

When a broken line is added to a character having a low character density, an edge is enhanced by the broken line, which may rather deteriorate the quality. In the printer 1, a broken line where the ratio of the line segments to the non-line segments is low is added to a character having a low character density. Therefore, the enhancement of the edge can be avoided. On the other hand, even when a broken line is added to a character having a high character density, the edge is less likely to be enhanced. In the printer 1, a broken line where the ratio of the line segments to the non-line segments is high is added to a character having a high character density. Therefore, the occurrence of jaggies can be preferentially suppressed.

The CPU 11 reads a second size threshold 252 from the memory 12 (S411), and determines whether the character size acquired in S301 of the density adjustment processing (refer to FIG. 5) is the read second size threshold 252 or more (S412). The second size threshold 252 is, for example, 10.5 point.

When the CPU 11 determines that the character size is the second size threshold 252 or more (S412: YES), the CPU 11 determines whether the type of the font designated by the text object to be printed is a font type including a thin line (S414). The font type having a thin line corresponds to, for example, a font type, such as Ming, including a character with a large number of strokes or a font type, such as Serif or a brush font, including a thin portion. For example, when the font type is Serif and is not italic and bold, the CPU 11 may determine that the font type is the font type including a thin line. For example, the CPU 11 may store font types such as Times New Roman and Ming as a list of the font types including a thin line in advance, or may inquire an external device such as a server to acquire the font type.

In addition, even when the CPU 11 determines that the character size is not the second size threshold 252 or more (S412: NO), the CPU 11 determines whether the designated font has the font type including a thin line (S416). The determination of S416 is the same as the determination of S414.

When the CPU 11 determines that the character size is the second size threshold 252 or more and the font type is the type including a thin line (S414: YES), or when the CPU 11 determines that the character size is less than the second size threshold 252 and the font type is not the type including a thin line (S416: NO), the CPU 11 adds the broken line of the broken line type determined in S405 to the outside of the edge of the character along the outline shape of the character in the intermediate data generated in S304 of the density adjustment processing (S421). S421 is an example of broken line addition processing. The CPU 11 adds the broken line to the outside of the intermediate data of the character without being superimposed on the intermediate data of the character.

Specifically, the CPU 11 disposes the broken line of the determined broken line type along the outline shape of the character acquired in S202 of the character intermediate data generation processing (refer to FIG. 3), and generates bitmap data of the broken line of the outline shape. Further, the CPU 11 adds the bitmap data of the broken line to the intermediate data that is the bitmap data generated in S304 of the density adjustment processing. As a result, the intermediate data where the broken line is added along the outline of the character to surround a character area 31 is generated. The CPU 11 stores the generated intermediate data in the temporary area of the memory 12.

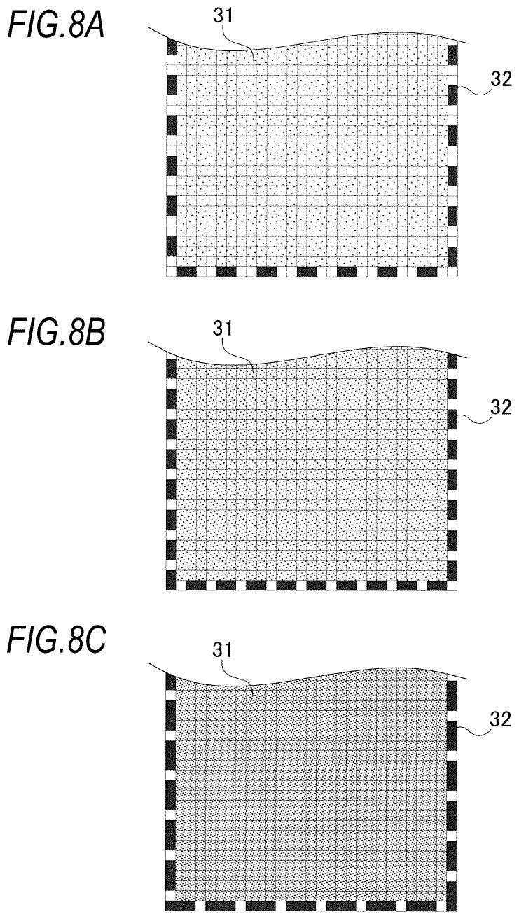

For example, as illustrated in some examples of FIGS. 8A to 8C, the CPU 11 adds a broken line to a broken line area 32 that is an area having a width of one dot adjacent to the outer periphery of the character area 31 as the image representing the character and disposed outside of the character area 31. As described above, the broken line type varies depending on the character density. FIG. 8A is an example where a broken line of a type D is added to the broken line area 32. FIG. 8B is an example where the broken line of the type C is added to the broken line area 32. FIG. 8C is an example where the broken line of the type B is added to the broken line area 32. The character areas 31 are gray colors having different densities, and black dots of the broken line area 32 are represented by black.

The intermediate data where the broken line is added along the outline of the character to surround the character area 31 does not need to be one piece of data. That is, the intermediate data may be a combination of the bitmap data of the character generated in S304 and the bitmap data of the broken line. In addition, instead of separately generating and adding the bitmap data representing the broken line of the outline shape of the character, the CPU 11 may directly add the broken line of the determined broken line type to the intermediate data generated in S304.

FIGS. 8A to 8C illustrate examples where the broken line area 32 is provided on the outside of the edge of the character area 31. The broken line area 32 to which the broken line is added may be an area having a width of one dot on the outermost periphery of the inside of the edge. That is, the broken line area 32 may include the character area 31. In this case, the CPU 11 rewrites the broken line on the outermost periphery of the character area 31 along the outline shape of the character.

On the other hand, when the CPU 11 determines that the character size is the second size threshold 252 or more and the font type is not the type including a thin line (S414: NO), the CPU 11 adds 1 to the number of black dots without changing the number of white dots of the broken line type candidate (S415). That is, the CPU 11 increases the black-to-white ratio of the broken line. As a result, in the case of a character that has a large character size and has a font type not including a thin line, the CPU 11 determines a broken line type having a higher black-to-white ratio than that of a character that has a large character size and has a font type including a thin line.

In addition, when the CPU 11 determines that the character size is less than the second size threshold 252 and the font type is the type including a thin line (S416: YES), the CPU 11 adds 1 to the number of white dots without changing the number of black dots of the broken line type candidate (S417). That is, the CPU 11 decreases the black-to-white ratio of the broken line. As a result, in the case of a character that has a small character size and has a font type including a thin line, the CPU 11 determines a broken line type having a lower black-to-white ratio than that of a character that has a small character size and has a font type not including a thin line.

After S415 or S417, the CPU 11 adds the broken line of the broken line type determined in S415 or S417 along the outline of the intermediate data generated in S304 of the density adjustment processing (refer to FIG. 5) (S421).

That is, in the case of the font type including a thin line, a broken line having a lower ratio of the line segments to the non-line segments than that of the font type not including a thin line is added. When the broken line is added to the thin line, the broken line is conspicuous, which may rather deteriorate the quality. In the printer 1, in the case of the font type including a thin line, a broken line having a lower black-to-white ratio than that of the font type not including a thin line is added. That is, in the printer 1, a gap of the broken line to be added to the character having a thin character shape is widened. Therefore, a reduction in the deterioration of the quality can be expected.

After S421, the CPU 11 ends the broken line type determination processing and returns to the density adjustment processing. In addition, when the CPU 11 determines that the character density is higher than the first density threshold 241, or when the CPU 11 determines that the character density is lower than the second density threshold 242 (S402: NO), the CPU 11 ends the broken line type determination processing without adding the broken line, and returns to the density adjustment processing. When the broken line is not added, the intermediate data generated in S304 is stored in the temporary area of the memory 12.

When the character density is high, even if dither processing is executed in the subsequent procedure, large chipping is less likely to occur in the edge of the character, and jaggies are less likely to occur. In addition, when the character density is low, the chipping of the edge is likely to be inconspicuous, and the occurrence of jaggies is less likely to cause a problem. In the printer 1, when the character density is higher than the first density threshold 241 or is lower than the second density threshold 242, a broken line is not added. Accordingly, in these cases, the processing of adding a broken line is avoided, and a processing burden is reduced.

On the other hand, when the character density is a half tone between the first density and the second density, the CPU 11 adds a broken line. In particular, as the character density decreases, a broken line having a lower ratio of the broken lines to the non-line segments is added. As a result, excessive enhancement of the character edge caused by surrounding with the broken line is avoided. On the other hand, when the character density is high, even when the character is surrounded with a broken line having a high ratio of the line segments to the non-line segments, the edge is less likely to be enhanced. In this case, the broken line having a high ratio of the line segments to the non-line segments is added, and thus the occurrence of jaggies is preferentially suppressed.

The description of the density adjustment processing of FIG. 5 will be given again. The CPU 11 ends the density adjustment processing after the broken line type determination processing of S312, and returns to the character intermediate data generation processing (FIG. 3).

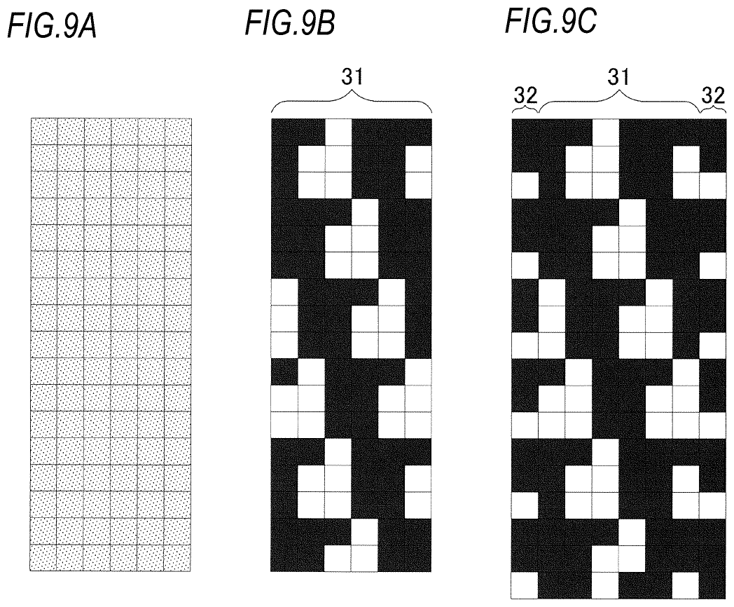

In addition, when the CPU 11 determines that the printing resolution is a low resolution (S311: YES), the CPU 11 ends the density adjustment processing without adding a broken line, and returns to the character intermediate data generation processing. When the printing resolution is a low resolution, for example, each of dots in a binarized image generated by dither processing from the original image illustrated in FIG. 9A is a large dot as illustrated in FIG. 9B. Therefore, for example, as illustrated in FIG. 9C, when the broken line area 32 is added along the outside of the character area 31, the broken line is conspicuous, which may rather deteriorate the quality. In the printer 1 according to the present embodiment, when the printing resolution is a low resolution, even if the character size is the first size threshold 251 or more, a broken line is not added. Therefore, the deterioration of the quality can be reduced.

On the other hand, when the CPU 11 determines that the character size is less than the first size threshold 251 (S303: NO), the CPU 11 determines whether the font has the font type including a thin line (S321). The determination of S321 may be the same as the determination of S414 or S416 of the broken line type determination processing, or may be made based on different standards. For example, a character that is less than 7 point is likely to include a thin line, and the possibility thereof further increases in the case of the font type including a thin line.

When the CPU 11 determines that the font has the font type including a thin line (S321: YES), the CPU 11 reads a third density threshold 243 of the density threshold 24 (refer to FIG. 1) from the memory 12 (S322). The third density threshold 243 is, for example, 20%. The CPU 11 determines whether the character density acquired in S301 is the read third density threshold 243 or less (S323). When the CPU 11 determines that the character density is the third density threshold 243 or less (S323: YES), the CPU 11 increases the character density (S324). S324 is an example of the density increasing processing. The CPU 11 sets the character density to be, for example, the third density threshold 243+5%.

After S324, the CPU 11 fills the inside of the outline shape of the character acquired in S202 of the character intermediate data generation processing (refer to FIG. 3) with the color of the character acquired in S203 and the increased character density, and generates intermediate data that is multivalued bitmap data (S325).

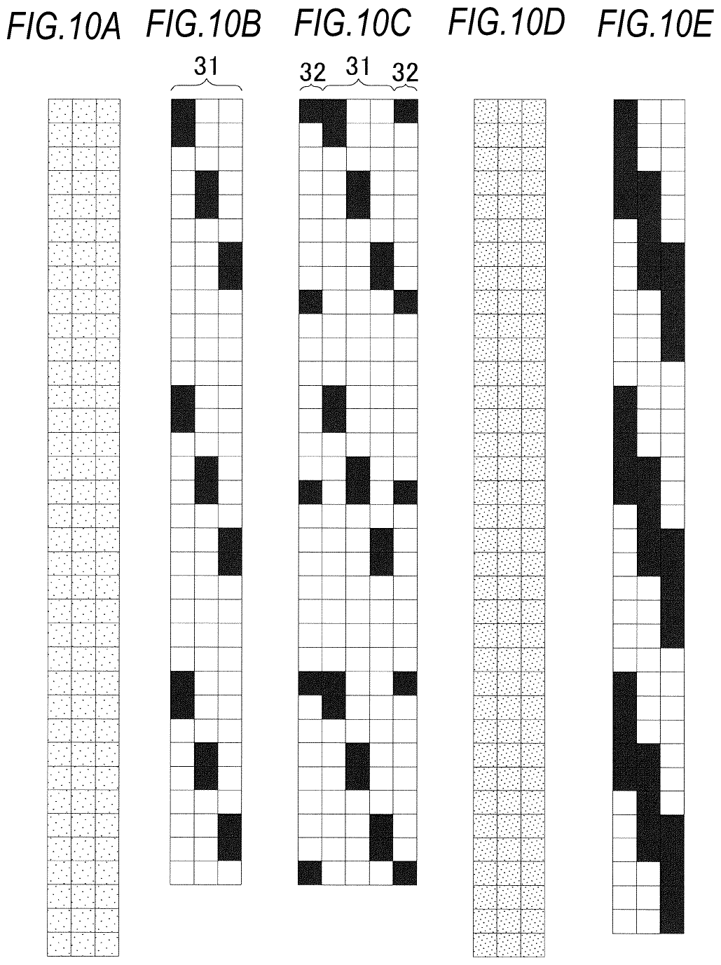

When the type of the font has the font type including a thin line and has a low character density, for example, a binarized image generated by dither processing from the original image illustrated in FIG. 10A is likely to be discontinuous in a particularly thin portion, for example, as illustrated in FIG. 10B, and thus is not likely to be recognized as a character. In this case, for example, as illustrated in FIG. 10C, even if the broken line area 32 is added along the outside of the character area 31, the possibility of improvement of the quality is low. In the printer 1 according to the present embodiment, when the character density of the thin character shape is low, for example, the image obtained by increasing the character density to obtain the image illustrated in FIG. 10D from the original image illustrated in FIG. 10A is the original image to be subjected to dither processing. The binarized image having the increased character density generated by dither processing from the original image is less likely to be discontinuous even in a thin portion of the character, for example, as illustrated in FIG. 10E, and the deterioration of the quality is reduced.

On the other hand, when the CPU 11 determines that the font does not have the font type including a thin line (S321: NO), or when the CPU 11 determines that the character density is higher than the third density threshold 243 (S323: NO), the CPU 11 fills the inside of the outline shape of the character acquired in S202 of the character intermediate data generation processing (refer to FIG. 3) with the color of the character acquired in S203, and generates intermediate data that is multivalued bitmap data (S325). In this case, the CPU 11 does not change the character density.

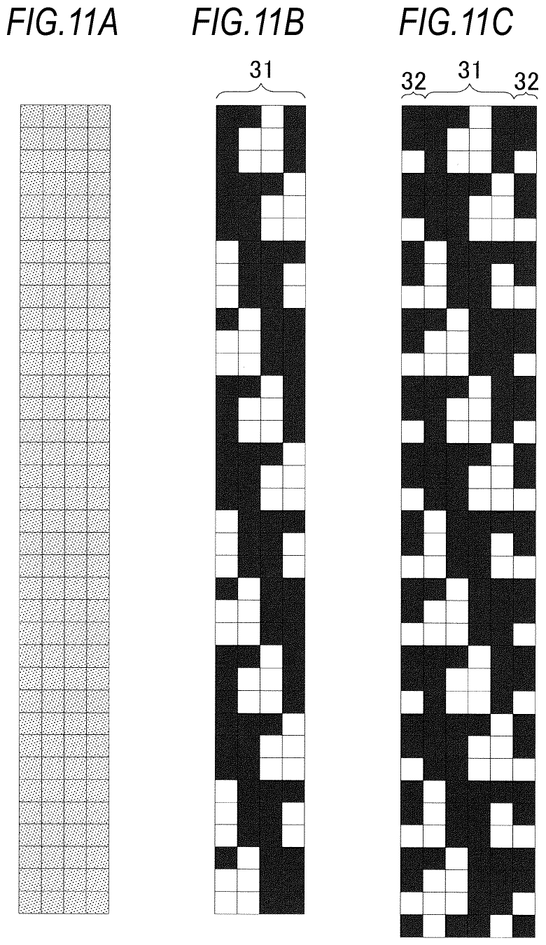

A character having a small character size includes a thin line to some extent even if the font thereof is not the font type including a thin line. Even in the thin line, unless the character density is low, for example, a binarized image generated by dither processing from the original image illustrated in FIG. 11A is likely to be, for example, a binarized image that is not discontinuous as illustrated in FIG. 11B. In this case, when a broken line is added, for example, the line becomes thick as illustrated in FIG. 11C. In the printer 1 according to the present embodiment, even when the character size is small, if the font does not have the font type including a thin line or if the font does not have the font type including a thin line but the character density is not low, intermediate data having the original character density is generated without adding a broken line. Therefore, the deterioration of the quality is reduced.

After S325, the CPU 11 ends the density adjustment processing, and returns to the character intermediate data generation processing of FIG. 3. In the character intermediate data generation processing of FIG. 3, the CPU 11 ends the character intermediate data generation processing after the end of the density adjustment processing of S215, and returns to the printing job processing of FIG. 2.

The remaining portion of the character intermediate data generation processing of FIG. 3 will be described. When the CPU 11 determines that the color of the character is similar to black (S213: YES), the CPU 11 fills the inside of the outline shape of the character acquired in S202 with black, that is, with the color where all of the R value, the G value, and the B value are 0, and generates intermediate data that is multivalued bitmap data (S221). The black intermediate data is a binarized image with only black dots even when the binarized image is generated by dither processing in the subsequent procedure.

When the color of the character is similar to black, even if the character is printed to be black, the appearance from the user is less likely to change. Even when the CPU 11 determines that the color of the character is similar to black, the printer 1 prints the black character without adding a broken line. Therefore, the occurrence of jaggies or character thickening can be suppressed, and the processing load can be further reduced. On the other hand, when the CPU 11 determines that the color of the character is not similar to black, the printer 1 does not add a broken line as described above. Therefore, it can be expected that the character is easy to read based on the color of the character.

In addition, when the CPU 11 determines that the mode of printing using only the colorant of the color K is not selected for the gray position (S211: NO), or when the CPU 11 determines that the color of the character to be processed is not gray (S212: NO), the CPU 11 fills the inside of the outline shape of the character acquired in S202 with the color of the character acquired in S203, and generates intermediate data that is multivalued bitmap data (S222). In this case, the CPU 11 does not add a broken line to the character.

In the case of the mode using colorants of a plurality of colors or when a character having a color other than gray is printed, the printer 1 generates a binarized image for each of the colors by executing dither processing for each of the colors of the colorants. In this case, the printer 1 executes dither processing using different dither patterns depending on the colors. Therefore, the positions of the dots are likely to vary depending on the colors, and jaggies are less likely to occur. In the case of the mode using colorants of a plurality of colors or when a character having a color other than gray is printed, the printer 1 does not add a broken line. Therefore, the processing load is reduced.

After S221 or S222, the CPU 11 ends the character intermediate data generation processing, and returns to the printing job processing.

The description of the printing job processing of FIG. 2 will be given again. The CPU 11 copies the intermediate data stored in the temporary area of the memory 12 in the character intermediate data generation processing of S115 to a drawing position designated by the text object in the memory area allocated in S102 (S116). In S116, the multivalued intermediate data generated based on the text object is disposed in the memory area corresponding to one page.

In addition, when the CPU 11 determines that the detected drawing object is not the text object (S112: NO), the CPU 11 generates intermediate data for each object (S117), and copies the intermediate data to the drawing position (S116).

The CPU 11 determines whether data representing an end of a page is acquired (S118). When the CPU 11 determines that the position is not the end of the page (S118: NO), the CPU 11 proceeds to S111, and further detects the drawing object.

The CPU 11 executes S115 to S117 for each of the drawing objects in the image data corresponding to one page. As a result, the multivalued intermediate data of each of the objects in one page is disposed in the memory area, and the multivalued image corresponding to one page is generated. That is, S116 is processing of generating the multivalued image, and is an example of multivalued image generation processing.

When the CPU 11 determines that the data representing the end of the page is not acquired (S118: YES), the CPU 11 executes color conversion on the multivalued image corresponding to one page that is generated in the memory area (S121). For example, when the printing device 15 of the printer 1 is a device for printing using colorants of four colors CMYK, the CPU 11 converts RGB data into CMYK data. The CPU 11 executes color conversion using a color conversion profile that is provided in advance. As a result, a multivalued image corresponding to one page that is represented by the CMYK data is generated. S121 may be an example of the multivalued image generation processing.

The CPU 11 binarizes the multivalued image after the color conversion to generate a binarized image (S122). S122 is an example of binarization processing. The binarization is processing of converting the multivalued image of each of the colors into two gray scales to generate a binarized image for the color. The CPU 11 executes, for example, dither processing using a dither matrix with the binarization program 22 (refer to FIG. 1) to generate binary bitmap data based on the multivalued bitmap data.

Specifically, the CPU 11 determines whether each of pixels in the multivalued image is an ON dot or an OFF dot for each of the colors. The ON dot is a pixel that forms a dot using a colorant in the printing device 15, and the OFF dot is a pixel that does not form a dot. For example, when the gray scale value of the multivalued image is more than or equal to a value represented by the dither matrix, the CPU 11 forms the ON dot, and when the gray scale value of the multivalued image is less than a value represented by the dither matrix, the CPU 11 forms the OFF dot. The dither matrix to be applied may vary depending on the colors.

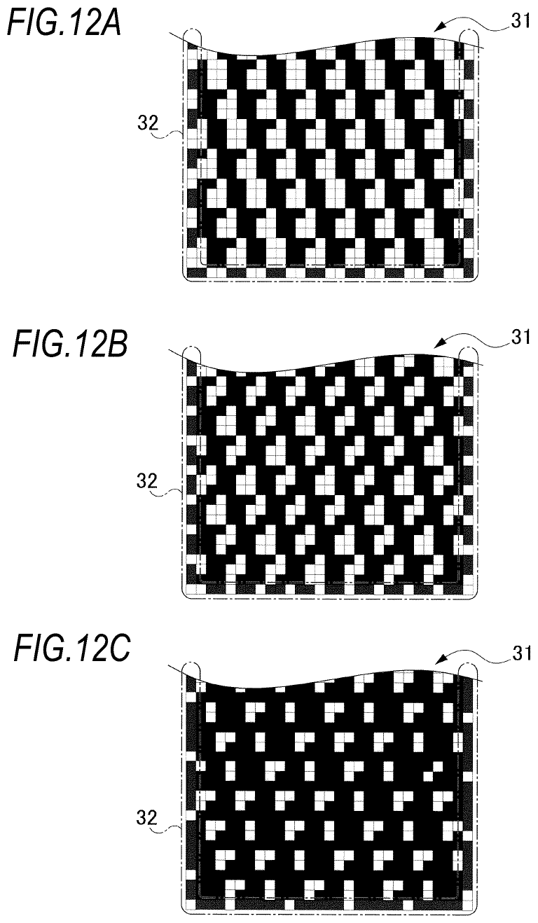

When the binarized image is generated based on the multivalued image of the character to which the broken line is added as in the example of FIGS. 8A to 8C, the binarized image includes the character area 31 processed by the dither matrix and the broken line area 32 formed by the added broken line, for example, as illustrated in a part of FIGS. 12A to 12C. When the broken line is added in the character intermediate data generation processing, the line segments of the added broken line are black dots having a density of 100%. Therefore, the line segments are the ON dots, and the non-line segments are the OFF dots. That is, even when the binarization processing is executed, the shape of the broken line is maintained. In addition, the broken line having a width of one dot is added, and thus character thickening is suppressed. In addition, the black-to-white ratio of the broken line is determined depending on the density of the character, and thus the excessive enhancement of the edge of the character is avoided.

The character area 31 of the gray character having a density of 50% is a dither pattern corresponding to the density of 50%, for example, as illustrated in FIG. 12A. Along the outline of the character area 31, a broken line having a black-to-white ratio of 1 is formed in the broken line area 32. In addition, the character area 31 of the gray character having a density of 60% is a dither pattern corresponding to the density of 60%, for example, as illustrated in FIG. 12B, and a broken line having a black-to-white ratio of 2 is formed in the broken line area 32. In addition, the character area 31 of the gray character having a density of 80% is a dither pattern corresponding to the density of 80%, for example, as illustrated in FIG. 12C, and a broken line having a black-to-white ratio of 3 is formed in the broken line area 32.

The binarization program 22 may be used for error diffusion processing instead of dither processing. In addition, when the printer 1 includes binarization hardware, the printer 1 may generate binarized data using the binarization hardware. The binarization hardware is hardware for binarizing the multivalued image, for example, in consideration of the edge appearing in the image. The binarization hardware may determine whether the pixel is likely to be the edge, for example, based on a difference in color between a target pixel and pixels around the target pixel such that, when the pixel is likely to be the edge and the density is high, the binarization hardware sets the pixel to be the ON dot.

The CPU 11 transmits the generated binarized image to the printing device 15 (S123), and executes printing. S123 is an example of printing processing. The CPU 11 may generate data in a format suitable for the printing device 15 based on the binarized image to transfer the data to the printing device 15. The printing device 15 executes printing based on the transmitted binarized image.

The CPU 11 determines whether the processing of the printing job ends (S124). When the CPU 11 determines that the processing of the printing job does not end (S124: NO), the CPU 11 proceeds to S103, and processes image data of the next page. When the CPU 11 determines that the processing of the printing job ends (S124: YES), the CPU 11 ends the printing job processing.

As described above in detail, the printer 1 according to the embodiment adds a broken line to the edge of the character in the image to be printed before generating the multivalued image. As a result, it can be expected that the broken line covers a part of large chipping exposed to the edge of the binarized character, the degree of chipping is reduced, and the chipping is likely to be inconspicuous. As a result, the occurrence of jaggies is suppressed.

In addition, when the size of the character is small, by adding a broken line, the broken line is conspicuous, which may rather deteriorate the quality. The printer 1 according to the present embodiment adds a broken line to a character having a predetermined size or more, and does not add a broken line to a small character. Therefore, the deterioration of the quality can be reduced.

In addition, when a character is printed using a plurality of colorants, positions where dots are formed vary depending on the colors, and the area of white portions is likely to decrease. Therefore, chipping is less likely to occur in the edge of the character. The printer 1 according to the present embodiment adds a broken line to a character that is printed using one colorant, and does not add a broken line to a character that is printed using a plurality of colorants. Therefore, the processing load can be reduced.

In the density adjustment processing illustrated in FIG. 5, the following may be considered: when the character size is the first size threshold 251 or more and the printing resolution is not a low resolution, a broken line is added: however, when the character size is the first size threshold 251 or more but the font has the font type including a thin line, a broken line is not added. Specifically, the CPU 11 may determine whether the font has the font type including a thin line instead of the determination of S303. When the font does not have the font type including a thin line, the CPU 11 may proceed to S304, and when the font has the font type including a thin line, the CPU 11 may proceed to S322. In the case of a thin character shape, a broken line is likely to be more conspicuous as compared to the case of a character shape that has the same density but is not thin, which rather deteriorate the quality. In the case of a thin character shape, the deterioration of the quality is reduced even without adding a broken line.

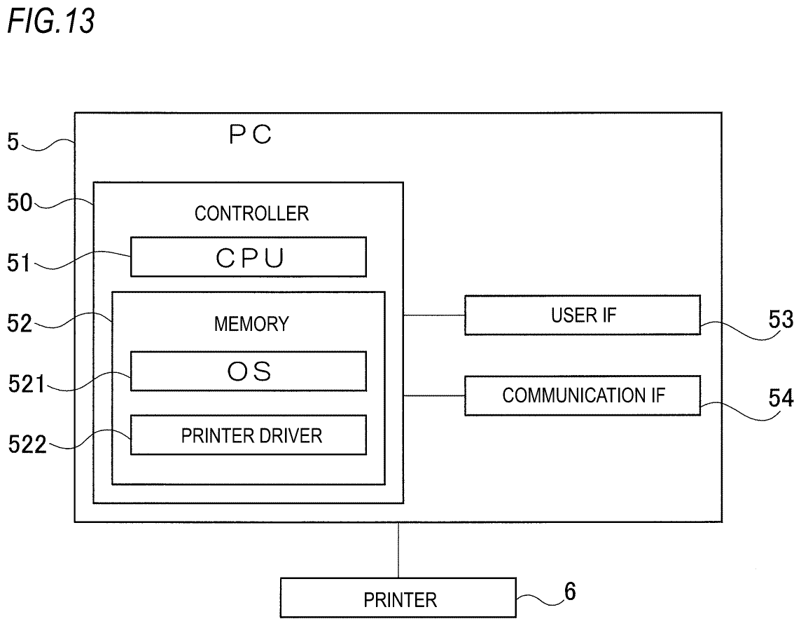

Next, an example where an information processing apparatus that can transmit a printing job to a printer executes a part of the same processing as the above-described printing job processing (refer to FIG. 2) will be described. For example, as illustrated in FIG. 13, a personal computer (hereinafter, referred to as “PC”) 5 is an apparatus that is connected to a printer 6 and can transmit a printing job to the printer 6. The PC 5 is an example of the information processing apparatus. The printer 6 is an apparatus that can execute printing based on the received printing job, and may or may not have the function of adding a broken line as in the above-described printer 1.

As illustrated in FIG. 13, the PC 5 includes a controller 50 including a CPU 51 and a memory 52. Further, the PC 5 includes a user IF 53 and a communication IF 54. The CPU 51 is an example of the computer. The memory 52 stores various programs or data including an OS 521 and a printer driver 522. The printer driver 522 is an example of a program corresponding to the printer 6.

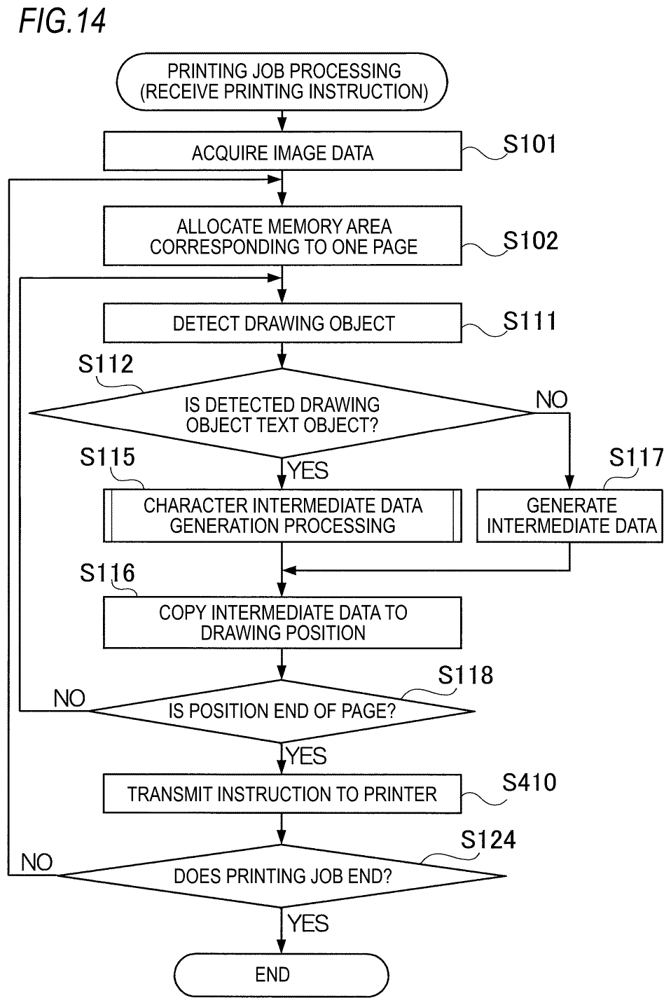

A procedure of printing job processing executed by the PC 5 will be described with reference to a flowchart of FIG. 14. This printing job processing is executed by the CPU 51 of the PC 5 based on the printer driver 522 when an instruction of printing is received from, for example, an application program that edits a document or displays an image. Hereinafter, the same procedure as that of the printing job processing executed by the above-described printer 1 is represented by the same reference numeral, and the description is simplified.

The CPU 51 of the PC 5 executes S101 to S118 based on the printer driver 522. The CPU 51 acquires image data representing an image to be printed from the application program that receives the printing instruction (S101). When a text object is detected from the image data (S112: YES), the CPU 51 executes character intermediate data generation processing. S101 is an example of acquisition processing. S112 is an example of character detection processing.

The character intermediate data generation processing is the same processing as the processing executed by the above-described printer 1. The PC 5 may inquire, for example, the printer 6 to determine whether the printing mode is a character mode or a photography mode. Alternatively, information regarding the printing mode may include the printing job. When the printing mode is the character mode and the color of the character is gray that is not similar to black (S213: NO), The CPU 51 executes the density adjustment processing illustrated in FIG. 5.

In the density adjustment processing, the CPU 51 determines whether to add a broken line and, if the broken line is added, determines a broken line type thereof based on the character data such as the character size, the character density, or the font type or based on the printing resolution, and generates intermediate data for each of the characters. Specifically, when the character size is the first size threshold 251 or more and the printing resolution is not a low resolution, the CPU 51 executes the broken line type determination processing illustrated in FIG. 6. The character data may be included in the printing job, or the CPU 51 may inquire the printer 6, a server, or the like to acquire the character data. Information regarding the printing resolution may be included in the printing job, or the CPU 51 may inquire the printer 6 to acquire the information.

When the character density is the first density threshold 241 or more and the second density threshold 242 or less (S402: YES), the CPU 51 determines a broken line type corresponding to the character density, and adds a broken line to the edge of the character (S421). S421 of the broken line type determination processing is an example of the broken line addition processing. As in the processing of the printer 1, the CPU 51 selects a broken line type having a higher black-to-white ratio for a higher character density.

Further, the CPU 51 corrects the black-to-white ratio of the broken line to be added based on whether the character size is the second size threshold 252 or more and based on whether the font type designated by the character data is a font type of a thin character shape including a thin line. Specifically, when the character size is the second size threshold 252 or more, the CPU 51 sets the black-to-white ratio to be higher than that when the character size is less than the second size threshold 252. In addition, when the font type has the thin character shape, the CPU 51 sets the black-to-white ratio to be lower than that when the font type does not have the thin character shape.

When the generation of the intermediate data corresponding to one page ends (S118: YES), the CPU 51 outputs a print command including the generated intermediate data to the printer 6, and instructs the printer 6 to execute printing (S410). S410 is an example of output processing. The printer 6 executes printing based on the print command output in S410. When the print command including the intermediate data that is a multivalued image is received as image data to be printed, the printer 6 can generate a binarized image to execute printing.

The PC 5 may generate intermediate data corresponding to all of the pages of the printing job instead of transmitting the intermediate data corresponding to one page such that the intermediate data corresponding to all of the pages is subsequently transmitted to the printer 6. In addition, the PC 5 may further execute color conversion processing or binarization processing to transmit the binarized image data to the printer 6.

As described above in detail, even in the embodiment where the PC 5 generates intermediate data and outputs the generated intermediate data to the printer 6, as in the case where the printer 1 generates the intermediate data, a broken line can be added to the edge of the character in the image to be printed before generating the multivalued image. Even in this case, the occurrence of jaggies is suppressed, and the deterioration of the quality is reduced.

Even in the density adjustment processing executed by the PC 5, when the character size is the first size threshold 251 or more, a broken line does not need to be added in the case of the font type including a thin line.

The embodiment is merely an example, and the present invention is not limited thereto. Accordingly, of course, various improvements and modifications can be made for the technique disclosed in the present specification within a range not departing from the scope of the technique. For example, the printer is not limited to the single printing function, and is applicable to any apparatus such as a multifunction peripheral, a copier, or a FAX machine as long as the apparatus has a color printing function. In addition, the apparatus that transmits the printing job to the printer is not limited to the PC and may be a smartphone, a tablet computer, or a server computer.

In addition, each of the density thresholds disclosed in the embodiment or the specific numerical value of each of the size thresholds is merely an example, and the present invention is not limited thereto. Each of the thresholds may vary depending on, for example, a model of the printer or may vary depending on the background or whether a shadow is present. In addition, in the embodiment, each of the thresholds is stored in the memory 12. However, each of the thresholds may be received from a value set by the user.

In addition, in the embodiment, broken lines having different black-to-white ratios are added depending on the density of the text object. However, the same broken line may be added irrespective of the density. Note that by selecting the black-to-white ratio of the broken line depending on the density, the edge can be prevented from being excessively conspicuous. In addition, the example of the four types of black-to-white ratios depending on the character density are described. However, the type of the black-to-white ratio is not limited to the four types.

In addition, in the embodiment, the broken line having a line width of one dot is added. However, the present invention is not limited to the example. For example, broken lines having different line widths may be added depending on the printing resolution or the character size. Specifically, a width of one dot is desired for an apparatus having an intermediate resolution, but a broken line having a width of two to three dots may be added for an apparatus having a high resolution. Note that, when the line width of the broken line is excessively large, the character may appear to be edged. Therefore, the broken line having a width of one dot is desirable.

In addition, in the embodiment, the broken line having a density of 100% is added. However, the present invention is not limited to the example. For example, broken lines having different densities that are higher than at least the character density may be added depending on the character density. Note that, when a broken line having a density other than 100% is added, the broken line is likely to be a target for dither processing. Therefore, a broken line having a density of 100% that is not a target for dither processing is desirable.

In addition, in the embodiment, the determination of the character size or the determination of whether the character includes a thin line is made based on the information regarding the font type but may be made depending on the characters.

In addition, in the embodiment, in the mode of printing a gray character using a plurality of colorants, the printer 1 does not add a broken line but may add a broken line. That is, S211 of the intermediate data generation processing does not need to be executed. In addition, when the color of the character is similar to black, the printer 1 changes the color of the character to black and adds a broken line. However, when the color of the character is similar to but is not black, a broken line may be added.

In addition, in the embodiment, when the character size is small, the font type has a thin character shape, or when the printing resolution is a low resolution, the printer 1 does not add a broken line but may add a broken line. In addition, in the embodiment, the printer 1 changes the black-to-white ratio of the broken line to be added depending on the character size or whether the font type has a thin character shape but may be configured not to change the black-to-white ratio of the broken line to be added.

In addition, when the PC connected to the printer is caused to generate the multivalued image, the OS may include a versatile program for printing in advance such that the PC has a driverless configuration of not using the printer driver. In the PC, a program supporting the printer may be incorporated separately from the versatile program in the OS. In this case, the PC may generate the multivalued image using this program. Even with this configuration, the program adds a broken line to the outline of the character such that the occurrence of jaggies can be suppressed.

In any of the flowcharts disclosed in the embodiment, the execution order of a plurality of processing in any plurality of steps can be changed within a range where there is no contradiction in the processing contents, or the plurality of processing can be executed in parallel.

In addition, the processing disclosed in the embodiment may be executed by hardware such as a single CPU, a plurality of CPUs, or an ASIC or by a combination thereof. In addition, the processing disclosed in the embodiment can be implemented in various aspects such as a recording medium storing a program for executing the processing or a method.

According to the present specification, a printer and a program according to the following aspects are provided.
(1) A printer including:
   a printing device: and
   a controller, in which
   the controller is capable of executing
   multivalued image generation processing of generating a multivalued image configured with multiple values based on the image data acquired in the acquisition processing,
   binarization processing of converting the multivalued image generated in the multivalued image generation processing into two gray scales to generate a binarized image, and
   printing processing of causing the printing device to execute printing based on the binarized image generated in the binarization processing,
   the controller is further configured
   to execute character detection processing of detecting character data representing a character from the image data acquired in the acquisition processing before executing the multivalued image generation processing and after executing the acquisition processing,
   when a size of the character represented by the character data detected in the character detection processing is a predetermined size or more, to execute broken line addition processing of adding a broken line to an edge of the character represented by the character data detected in the character detection processing and to generate the multivalued image in the multivalued image generation processing based on the character to which the broken line is added in the broken line addition processing, and
   when the size of the character represented by the character data detected in the character detection processing is less than the predetermined size, not to execute the broken line addition processing.
(2) In the printer according to (1),
   when the size of the character represented by the character data detected in the character detection processing is a predetermined size or more and the character represented by the character data does not have a thin character shape, the controller is configured to execute the broken line addition processing and to generate the multivalued image in the multivalued image generation processing based on the character to which the broken line is added in the broken line addition processing, and
   when the size of the character represented by the character data detected in the character detection processing is less than the predetermined size or when the character represented by the character data has a thin character shape, the controller is configured to execute density increasing processing of increasing a density of the character represented by the character data detected in the character detection processing without executing the broken line addition processing and to generate the multivalued image in the multivalued image generation processing based on the character of which the density is increased in the density increasing processing.
(3) In the printer according to (1),
   the broken line to be added in the broken line addition processing includes a plurality of line segments and a plurality of non-line segments between the line segments and, when the size of the character is a first size, a ratio of the line segments to the non-line segments at the first size is lower than that at a second size more than the first size.
(4) In the printer according to (1),
   the broken line to be added in the broken line addition processing includes a plurality of line segments and a plurality of non-line segments between the line segments and, when the character represented by the character data detected in the character detection processing has a thin character shape, a ratio of the line segments to the non-line segments is lower than that at a second density higher than that when the character represented by the character data does not have a thin character shape.
(5) In the printer according to (1),
   when the size of the character represented by the character data detected in the character detection processing is a predetermined size or more and a printing resolution is a predetermined resolution or higher, the controller is configured to execute the broken line addition processing and to generate the multivalued image in the multivalued image generation processing based on the character to which the broken line is added in the broken line addition processing,
   when the size of the character represented by the character data detected in the character detection processing is the predetermined size or more but the printing resolution is lower than the predetermined resolution, the controller is configured not to execute the broken line addition processing, and
   when the size of the character represented by the character data detected in the character detection processing is less than the predetermined size, the controller is configured not to execute the broken line addition processing.
(6) A printer including:
   a printing device: and
   a controller, in which
   the controller is capable of executing
   acquisition processing of acquiring image data,
   multivalued image generation processing of generating a multivalued image configured with multiple values based on the image data acquired in the acquisition processing,
   binarization processing of converting the multivalued image generated in the multivalued image generation processing into two gray scales to generate a binarized image, and
   printing processing of causing the printing device to execute printing based on the binarized image generated in the binarization processing,
   the controller is further configured to execute
   character detection processing of detecting character data representing a character from the image data acquired in the acquisition processing before executing the multivalued image generation processing and after executing the acquisition processing, and
   broken line addition processing of adding a broken line to an edge of the character represented by the character data detected in the character detection processing, and
   the broken line to be added in the broken line addition processing includes a plurality of line segments and a plurality of non-line segments between the line segments and, when the character represented by the character data detected in the character detection processing has a thin character shape, a ratio of the line segments to the non-line segments is lower than that at a second density higher than that when the character represented by the character data does not have a thin character shape.
(7) A printer including:
   a printing device: and
   a controller, in which
   the controller is capable of executing
   acquisition processing of acquiring image data,
   multivalued image generation processing of generating a multivalued image configured with multiple values based on the image data acquired in the acquisition processing,
   binarization processing of converting the multivalued image generated in the multivalued image generation processing into two gray scales to generate a binarized image, and
   printing processing of causing the printing device to execute printing based on the binarized image generated in the binarization processing,
   the controller is further configured
   to execute character detection processing of detecting character data representing a character from the image data acquired in the acquisition processing before executing the multivalued image generation processing and after executing the acquisition processing,
   when a printing resolution is a predetermined resolution or higher, to execute broken line addition processing of adding a broken line to an edge of the character represented by the character data detected in the character detection processing and to generate the multivalued image in the multivalued image generation processing based on the character to which the broken line is added in the broken line addition processing, and
   when the printing resolution is lower than the predetermined resolution, not to execute the broken line addition processing.
(8) A printer including:
   a printing device: and
   a controller, in which
   the controller is capable of executing
   acquisition processing of acquiring image data,
   multivalued image generation processing of generating a multivalued image configured with multiple values based on the image data acquired in the acquisition processing,
   binarization processing of converting the multivalued image generated in the multivalued image generation processing into two gray scales to generate a binarized image, and
   printing processing of causing the printing device to execute printing based on the binarized image generated in the binarization processing, and
   the controller is further configured
   to execute character detection processing of detecting character data representing a character from the image data acquired in the acquisition processing before executing the multivalued image generation processing and after executing the acquisition processing,
   when the character represented by the character data detected in the character detection processing does not have a thin character shape, to execute broken line addition processing of adding a broken line to an edge of the character represented by the character data detected in the character detection processing and to generate the multivalued image in the multivalued image generation processing based on the character to which the broken line is added in the broken line addition processing, and
   when the character represented by the character data detected in the character detection processing has a thin character shape, not to execute the broken line addition processing.
(9) In the printer according to (8),
   when the character represented by the character data detected in the character detection processing does not have a thin character shape, the controller is configured to execute the broken line addition processing and to generate the multivalued image in the multivalued image generation processing based on the character to which the broken line is added in the broken line addition processing, and
   when the character represented by the character data detected in the character detection processing has a thin character shape, the controller is configured to execute density increasing processing of increasing a density of the character represented by the character data detected in the character detection processing without executing the broken line addition processing and to generate the multivalued image in the multivalued image generation processing based on the character of which the density is increased in the density increasing processing.
(10) A printer including:
   a printing device: and
   a controller, in which
   the controller is capable of executing
   acquisition processing of acquiring image data,
   multivalued image generation processing of generating a multivalued image configured with multiple values based on the image data acquired in the acquisition processing,
   binarization processing of converting the multivalued image generated in the multivalued image generation processing into two gray scales to generate a binarized image, and
   printing processing of causing the printing device to execute printing based on the binarized image generated in the binarization processing,
   the controller is further configured
   character detection processing of detecting character data representing a character from the image data acquired in the acquisition processing before executing the multivalued image generation processing and after executing the acquisition processing, and
   broken line addition processing of adding a broken line to an edge of the character represented by the character data detected in the character detection processing, and
   the broken line to be added in the broken line addition processing includes a plurality of line segments and a plurality of non-line segments between the line segments and, when the size of the character represented by the character data detected in the character detection processing is a first size, a ratio of the line segments to the non-line segments at the first size is lower than that at a second size more than the first size.
(11) In the printer according to (8),
   the broken line to be added in the broken line addition processing includes a plurality of line segments and a plurality of non-line segments between the line segments and, when a density of the character represented by the character data detected in the character detection processing is a first density, a ratio of the line segments to the non-line segments at the first density is lower than that at a second density higher than the first density.
(12) In the printer according to (1),
   when a density of the character represented by the character data detected in the character detection processing is higher than a first threshold, the controller is configured not to execute the broken line addition processing, and the first threshold is higher than 70%.
(13) In the printer according to (1),
   when a density of the character represented by the character data detected in the character detection processing is lower than a second threshold, the controller is configured not to execute the broken line addition processing, and the second threshold is lower than 60%.
(14) In the printer according to any one of (1) to (13),
   the controller is configured
   in the character detection processing, to detect a text object as the character data from the image data acquired in the acquisition processing,
   in the broken line addition processing, to acquire data representing an outline shape of each of characters represented by the text object detected in the character detection processing and to generate intermediate data to which the broken line is added along the outline shape represented by the acquired data, and
   in the multivalued image generation processing, to generate the multivalued image based on the intermediate data generated in the broken line addition processing.
(15) In the printer according to (14),
   in the broken line addition processing, the controller is configured to acquire data representing an outline shape of each of characters represented by the text object detected in the character detection processing and to generate the intermediate data where the broken line is added to an inside of an edge of a character along the outline shape represented by the acquired data.
(16) In the printer according to (14),
   in the broken line addition processing, the controller is configured to acquire data representing an outline shape of each of characters represented by the text object detected in the character detection processing and to generate the intermediate data where the broken line is added to an outside of an edge of a character along the outline shape represented by the acquired data.
(17) In the printer according to any one of (1) to (13),
   the controller is configured to add the broken line having a width of one dot in the broken line addition processing.
(18) In the printer according to any one of (1) to (13),
   the controller is configured to add the broken line having a density of 100% in the broken line addition processing.
(19) In the printer according to any one of (1) to (13),
   the broken line to be added in the broken line addition processing includes a plurality of line segments and a plurality of non-line segments between the line segments,
   a length of each of the line segments corresponds to the number of consecutive black dots, and
   a length of each of the non-line segments corresponds to the number of consecutive white dots.
(20) In the printer according to any one of (1) to (13),
   the broken line to be added in the broken line addition processing includes a plurality of line segments and a plurality of non-line segments between the line segments,
   a length of each of the line segments is proportional to the number of consecutive black dots, and
   a length of each of the non-line segments is proportional to the number of consecutive white dots.
(21) A program that is executable by a computer of an information processing apparatus and supports a printer connected to the information processing apparatus, in which
   the program is capable of causing the computer to execute
   acquisition processing of acquiring image data, and
   output processing of outputting a print command for causing the printer to print an image based on the image data acquired in the acquisition processing, and
   the program further causes the computer
   to execute character detection processing of detecting character data representing a character from the image data acquired in the acquisition processing before executing the output processing and after executing the acquisition processing,
   when a size of the character represented by the character data detected in the character detection processing is a predetermined size or more, to execute broken line addition processing of adding a broken line to an edge of the character represented by the character data detected in the character detection processing and, in the output processing, to output the print command for causing the printer to print the image including the character to which the broken line is added in the broken line addition processing, and
   when the size of the character represented by the character data detected in the character detection processing is less than the predetermined size, not to execute the broken line addition processing.
(22) A program that is executable by a computer of an information processing apparatus and supports a printer connected to the information processing apparatus, in which
   the program is capable of causing the computer to execute
   acquisition processing of acquiring image data, and
   output processing of outputting a print command for causing the printer to print an image based on the image data acquired in the acquisition processing,
   the program further causes the computer to execute
   character detection processing of detecting character data representing a character from the image data acquired in the acquisition processing before executing the output processing and after executing the acquisition processing, and
   broken line addition processing of adding a broken line to an edge of the character represented by the character data detected in the character detection processing, and
   the broken line to be added in the broken line addition processing includes a plurality of line segments and a plurality of non-line segments between the line segments and, when the character represented by the character data detected in the character detection processing has a thin character shape, a ratio of the line segments to the non-line segments is lower than that at a second density higher than that when the character represented by the character data does not have a thin character shape.
(23) A program that is executable by a computer of an information processing apparatus and supports a printer connected to the information processing apparatus, in which
   the program is capable of causing the computer to execute
   acquisition processing of acquiring image data, and
   output processing of outputting a print command for causing the printer to print an image based on the image data acquired in the acquisition processing, and
   the program further causes the computer
   to execute character detection processing of detecting character data representing a character from the image data acquired in the acquisition processing before executing the output processing and after executing the acquisition processing,
   when a printing resolution is a predetermined resolution or higher, to execute broken line addition processing of adding a broken line to an edge of the character represented by the character data detected in the character detection processing, and, in the output processing, to output the print command for causing the printer to print the image including the character to which the broken line is added in the broken line addition processing, and
   when the printing resolution is lower than the predetermined resolution, not to execute the broken line addition processing.
(24) A program that is executable by a computer of an information processing apparatus and supports a printer connected to the information processing apparatus, in which
   the program is capable of causing the computer to execute
   acquisition processing of acquiring image data, and
   output processing of outputting a print command for causing the printer to print an image based on the image data acquired in the acquisition processing, and
   the program further causes the computer
   to execute character detection processing of detecting character data representing a character from the image data acquired in the acquisition processing before executing the output processing and after executing the acquisition processing,
   when the character represented by the character data detected in the character detection processing does not have a thin character shape, to execute broken line addition processing of adding a broken line to an edge of the character represented by the character data detected in the character detection processing, and, in the output processing, to output the print command for causing the printer to print the image including the character to which the broken line is added in the broken line addition processing, and
   when the character represented by the character data detected in the character detection processing has a thin character shape, not to execute the broken line addition processing.
(25) A program that is executable by a computer of an information processing apparatus and supports a printer connected to the information processing apparatus, in which
   the program is capable of causing the computer to execute
   acquisition processing of acquiring image data, and
   output processing of outputting a print command for causing the printer to print an image based on the image data acquired in the acquisition processing,
   the program further causes the computer to execute
   character detection processing of detecting character data representing a character from the image data acquired in the acquisition processing before executing the output processing and after executing the acquisition processing, and
   broken line addition processing of adding a broken line to an edge of the character represented by the character data detected in the character detection processing, and
   the broken line to be added in the broken line addition processing includes a plurality of line segments and a plurality of non-line segments between the line segments and, when the size of the character represented by the character data detected in the character detection processing is a first size, a ratio of the line segments to the non-line segments at the first size is lower than that at a second size more than the first size.
(26) A printer including:
   a printing device: and
   a controller, in which
   the controller is capable of executing
   acquisition processing of acquiring image data,
   multivalued image generation processing of generating a multivalued image configured with multiple values based on the image data acquired in the acquisition processing,
   binarization processing of converting the multivalued image generated in the multivalued image generation processing into two gray scales to generate a binarized image, and
   printing processing of causing the printing device to execute printing based on the binarized image generated in the binarization processing,
   the controller is further configured to execute character detection processing of detecting character data representing a character from the image data acquired in the acquisition processing before executing the multivalued image generation processing and after executing the acquisition processing,
   when the character represented by the character data detected in the character detection processing is printed using one colorant, the controller is further configured to execute broken line addition processing of adding a broken line to an edge of the character and to generate the multivalued image in the multivalued image generation processing based on the character to which the broken line is added in the broken line addition processing, and
   when the character represented by the character data detected in the character detection processing is printed using a plurality of colorants, the controller is further configured not to execute the broken line addition processing.
(27) In the printer according to (26),
   as a mode for printing a character, a first mode for printing a gray character using a black colorant and a second mode for printing a gray character using a plurality of colorants are provided,
   when a color of the character represented by the character data detected in the character detection processing is gray and the printer operates in the first mode, the controller is configured to execute the broken line addition processing and to generate the multivalued image in the multivalued image generation processing based on the character to which the broken line is added in the broken line addition processing, and
   when a color of the character represented by the character data detected in the character detection processing is not gray or the printer operates in the second mode, the controller is configured not to execute the broken line addition processing.
(28) In the printer according to (26),
   when a color of the character represented by the character data detected in the character detection processing is gray without being similar to black and the character is printed using one colorant, the controller is configured to execute the broken line addition processing and to generate the multivalued image in the multivalued image generation processing based on the character to which the broken line is added in the broken line addition processing, and
   when a color of the character represented by the character data detected in the character detection processing is not gray or is similar to both of gray and black or the character is printed using a plurality of colorants, the controller is configured not to execute the broken line addition processing.
(29) A printer including:
   a printing device: and
   a controller, in which
   the controller is capable of executing
   acquisition processing of acquiring image data,
   multivalued image generation processing of generating a multivalued image configured with multiple values based on the image data acquired in the acquisition processing,
   binarization processing of converting the multivalued image generated in the multivalued image generation processing into two gray scales to generate a binarized image, and
   printing processing of causing the printing device to execute printing based on the binarized image generated in the binarization processing,
   the controller is further configured to execute character detection processing of detecting character data representing a character from the image data acquired in the acquisition processing before executing the multivalued image generation processing and after executing the acquisition processing, and
   in a case where a color of the character represented by the character data detected in the character detection processing is gray,
   when the color is not similar to black, the controller is further configured to execute broken line addition processing of adding a broken line to an edge of the character and to generate the multivalued image in the multivalued image generation processing based on the character to which the broken line is added in the broken line addition processing, and
   when the color is similar to black, the controller is further configured not to execute the broken line addition processing.
(30) In the printer according to (29),
   in a case where a color of the character represented by the character data detected in the character detection processing is gray, the controller determines that the color is similar to black when an average value of RGB values is a threshold or less, and determines that the color is not similar to black when the average value is more than the threshold,
   regarding the character of which the color is determined not to be similar to black, the controller is configured to execute the broken line addition processing and to generate the multivalued image in the multivalued image generation processing based on the character to which the broken line is added in the broken line addition processing, and
   regarding the character of which the color is determined to be similar to black, the controller is configured not to execute the broken line addition processing.
(31) In the printer according to (29),
   in a case where a color of the character represented by the character data detected in the character detection processing is gray,
   when the color is not similar to black, the controller is configured to execute the broken line addition processing and to generate the multivalued image in the multivalued image generation processing based on the character to which the broken line is added in the broken line addition processing, and
   when the color is similar to black, the controller is configured to print the character as a black character without executing the broken line addition processing.
(32) In the printer according to (26),
   the broken line to be added in the broken line addition processing includes a plurality of line segments and a plurality of non-line segments between the line segments and, when a density of the character represented by the character data detected in the character detection processing is a first density, a ratio of the line segments to the non-line segments at the first density is lower than that at a second density higher than the first density.
(33) In the printer according to (26),
   when a density of the character represented by the character data detected in the character detection processing is higher than a first threshold, the controller is configured not to execute the broken line addition processing, and the first threshold is higher than 70%.
(34) In the printer according to (26),
   when a density of the character represented by the character data detected in the character detection processing is lower than a second threshold, the controller is configured not to execute the broken line addition processing, and the second threshold is lower than 60%.
(35) In the printer according to any one of (26) to (34),
   the controller is configured
   in the character detection processing, to detect a text object as the character data from the image data acquired in the acquisition processing,
   in the broken line addition processing, to acquire data representing an outline shape of each of characters represented by the text object detected in the character detection processing and to generate intermediate data to which the broken line is added along the outline shape represented by the acquired data, and
   in the multivalued image generation processing, to generate the multivalued image based on the intermediate data generated in the broken line addition processing.
(36) In the printer according to (35),
   in the broken line addition processing, the controller is configured to acquire data representing an outline shape of each of characters represented by the text object detected in the character detection processing and to generate the intermediate data where the broken line is added to an inside of an edge of a character along the outline shape represented by the acquired data.
(37) In the printer according to (35),
   in the broken line addition processing, the controller is configured to acquire data representing an outline shape of each of characters represented by the text object detected in the character detection processing and to generate the intermediate data where the broken line is added to an outside of an edge of a character along the outline shape represented by the acquired data.
(38) In the printer according to any one of (26) to (34),
   the controller is configured to add the broken line having a width of one dot in the broken line addition processing.
(39) In the printer according to any one of (26) to (34),
   the controller is configured to add the broken line having a density of 100% in the broken line addition processing.
(40) In the printer according to any one of (26) to (34),
   the broken line to be added in the broken line addition processing includes a plurality of line segments and a plurality of non-line segments between the line segments,
   a length of each of the line segments corresponds to the number of consecutive black dots, and
   a length of each of the non-line segments corresponds to the number of consecutive white dots.
(41) In the printer according to any one of (26) to (34),
   the broken line to be added in the broken line addition processing includes a plurality of line segments and a plurality of non-line segments between the line segments,
   a length of each of the line segments is proportional to the number of consecutive black dots, and
   a length of each of the non-line segments is proportional to the number of consecutive white dots.
(42) A non-transitory computer readable storage medium storing a program that is executable by a computer of an information processing apparatus and supports a printer connected to the information processing apparatus, in which
   the program is capable of causing the computer to execute
   acquisition processing of acquiring image data, and
   output processing of outputting a print command for causing the printer to print an image based on the image data acquired in the acquisition processing,
   the program further causes the computer to execute character detection processing of detecting character data representing a character from the image data acquired in the acquisition processing before executing the output processing and after executing the acquisition processing,
   when the character represented by the character data detected in the character detection processing is printed using one colorant, the program further causes the computer to execute broken line addition processing of adding a broken line to an edge of the character represented by the character data detected in the character detection processing, and, in the output processing, to output the print command for causing the printer to print the image including the character to which the broken line is added in the broken line addition processing, and
   when the character represented by the character data detected in the character detection processing is printed using a plurality of colorants, the program further causes the computer not to execute the broken line addition processing.
(43) A non-transitory computer readable storage medium storing a program that is executable by a computer of an information processing apparatus and supports a printer connected to the information processing apparatus, in which
   the program is capable of causing the computer to execute
   acquisition processing of acquiring image data, and
   output processing of outputting a print command for causing the printer to print an image based on the image data acquired in the acquisition processing,
   the program further causes the computer to execute character detection processing of detecting character data representing a character from the image data acquired in the acquisition processing before executing the output processing and after executing the acquisition processing, and
   in a case where a color of the character represented by the character data detected in the character detection processing is gray,
   when the color is not similar to black, the program causes the computer to execute broken line addition processing of adding a broken line to an edge of the character and, in the output processing, to output the print command for causing the printer to print the image including the character to which the broken line is added in the broken line addition processing, and
   when the color is similar to black, the program causes the computer not to execute the broken line addition processing.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A printer comprising:
a printing device; and
a controller, wherein
the controller is capable of executing
acquisition processing of acquiring image data,
multivalued image generation processing of generating a multivalued image configured with multiple values based on the image data acquired in the acquisition processing,
binarization processing of converting the multivalued image generated in the multivalued image generation processing into two gray scales to generate a binarized image, and
printing processing of causing the printing device to execute printing based on the binarized image generated in the binarization processing, and
the controller is further configured
to execute character detection processing of detecting character data representing a character from the image data acquired in the acquisition processing before executing the multivalued image generation processing and after executing the acquisition processing,
when a predetermined condition is satisfied, to execute broken line addition processing of adding a broken line to an edge of the character represented by the character data detected in the character detection processing and to generate the multivalued image in the multivalued image generation processing based on the character to which the broken line is added in the broken line addition processing, and
when the predetermined condition is not satisfied, not to execute the broken line addition processing.

2. The printer according to claim 1, wherein
the predetermined condition is that a size of the character represented by the character data detected in the character detection processing is a predetermined size or more.

3. The printer according to claim 1, wherein
the predetermined condition is that a printing resolution is a predetermined resolution or more.

4. The printer according to claim 1, wherein
the predetermined condition is that the character represented by the character data detected in the character detection processing does not have a thin character shape.

5. The printer according to claim 4, wherein
when the predetermined condition is satisfied, the controller is configured to execute the broken line addition processing and to generate the multivalued image in the multivalued image generation processing based on the character to which the broken line is added in the broken line addition processing, and
when the predetermined condition is not satisfied, the controller is configured to execute density increasing processing of increasing a density of the character represented by the character data detected in the character detection processing without executing the broken line addition processing and to generate the multivalued image in the multivalued image generation processing based on the character of which the density is increased in the density increasing processing.

6. The printer according to claim 1, wherein
when the character represented by the character data detected in the character detection processing is printed using one colorant, the controller is further configured to execute broken line addition processing of adding a broken line to an edge of the character and to generate the multivalued image in the multivalued image generation processing based on the character to which the broken line is added in the broken line addition processing, and
when the character represented by the character data detected in the character detection processing is printed using a plurality of colorants, not to execute the broken line addition processing.

7. The printer according to claim 6, wherein
as a mode for printing a character, a first mode for printing a gray character using a black colorant and a second mode for printing a gray character using a plurality of colorants are provided,
when a color of the character represented by the character data detected in the character detection processing is gray and the printer operates in the first mode, the controller is configured to execute the broken line addition processing and to generate the multivalued image in the multivalued image generation processing based on the character to which the broken line is added in the broken line addition processing, and
when a color of the character represented by the character data detected in the character detection processing is not gray or the printer operates in the second mode, the controller is configured not to execute the broken line addition processing.

8. The printer according to claim 6, wherein
when a color of the character represented by the character data detected in the character detection processing is gray without being similar to black and the character is printed using one colorant, the controller is configured to execute the broken line addition processing and to generate the multivalued image in the multivalued image generation processing based on the character to which the broken line is added in the broken line addition processing, and
when a color of the character represented by the character data detected in the character detection processing is not gray or is similar to both of gray and black or the character is printed using a plurality of colorants, the controller is configured not to execute the broken line addition processing.

9. The printer according to claim 1, wherein
in a case where a color of the character represented by the character data detected in the character detection processing is gray,
when the color is not similar to black, the controller is further configured to execute broken line addition processing of adding a broken line to an edge of the character and to generate the multivalued image in the multivalued image generation processing based on the character to which the broken line is added in the broken line addition processing, and
when the color is similar to black, the controller is further configured not to execute the broken line addition processing.

10. The printer according to claim 9, wherein
in a case where a color of the character represented by the character data detected in the character detection processing is gray, the controller determines that the color is similar to black when an average value of RGB values is a threshold or less, and determines that the color is not similar to black when the average value is more than the threshold,
regarding the character of which the color is determined not to be similar to black, the controller is configured to execute the broken line addition processing and to generate the multivalued image in the multivalued image generation processing based on the character to which the broken line is added in the broken line addition processing, and
regarding the character of which the color is determined to be similar to black, the controller is configured not to execute the broken line addition processing.

11. The printer according to claim 9, wherein
in a case where a color of the character represented by the character data detected in the character detection processing is gray,
when the color is not similar to black, the controller is configured to execute the broken line addition processing and to generate the multivalued image in the multivalued image generation processing based on the character to which the broken line is added in the broken line addition processing, and
when the color is similar to black, the controller is configured to print the character as a black character without executing the broken line addition processing.

12. The printer according to claim 1, wherein
the broken line to be added in the broken line addition processing includes a plurality of line segments and a plurality of non-line segments between the line segments and, when a density of the character represented by the character data detected in the character detection processing is a first density, a ratio of the line segments to the non-line segments at the first density is lower than that at a second density higher than the first density.

13. The printer according to claim 1, wherein
the controller is configured to add the broken line having a width of one dot in the broken line addition processing.

14. A printer comprising:
a printing device; and
a controller, wherein
the controller is configured to execute
acquisition processing of acquiring image data,
multivalued image generation processing of generating a multivalued image configured with multiple values based on the image data acquired in the acquisition processing,
binarization processing of converting the multivalued image generated in the multivalued image generation processing into two gray scales to generate a binarized image, and
printing processing of causing the printing device to execute printing based on the binarized image generated in the binarization processing,
the controller is further configured to execute
character detection processing of detecting character data representing a character from the image data acquired in the acquisition processing before executing the multivalued image generation processing and after executing the acquisition processing, and
broken line addition processing of adding a broken line to an edge of the character represented by the character data detected in the character detection processing, and
the broken line to be added in the broken line addition processing includes a plurality of line segments and a plurality of non-line segments between the line segments and, a ratio of the line segments to the non-line segments when a predetermined condition is satisfied is lower than that when the predetermined condition is not satisfied.

15. The printer according to claim 14, wherein
the predetermined condition is that the character represented by the character data detected in the character detection processing has a thin character shape.

16. The printer according to claim 14, wherein
the predetermined condition is satisfied when a size of the character represented by the character data detected in the character detection processing is a first size, and
the predetermined condition is not satisfied when the size of the character represented by the character data detected in the character detection processing is a second size more than the first size.

17. The printer according to claim 14, wherein
the broken line to be added in the broken line addition processing includes a plurality of line segments and a plurality of non-line segments between the line segments and, when a density of the character represented by the character data detected in the character detection processing is a first density, a ratio of the line segments to the non-line segments at the first density is lower than that at a second density higher than the first density.

18. The printer according to claim 14, wherein
the controller is configured to add the broken line having a width of one dot in the broken line addition processing.

19. A non-transitory computer readable storage medium storing a program that is executable by a computer of an information processing apparatus and supports a printer connected to the information processing apparatus, wherein
the program is capable of causing the computer to execute
acquisition processing of acquiring image data, and
output processing of outputting a print command for causing the printer to print an image based on the image data acquired in the acquisition processing, and
the program further causes the computer
to execute character detection processing of detecting character data representing a character from the image data acquired in the acquisition processing before executing the output processing and after executing the acquisition processing,
when a predetermined condition is satisfied, to execute broken line addition processing of adding a broken line to an edge of the character represented by the character data detected in the character detection processing and to output the print command in the output processing based on the character to which the broken line is added in the broken line addition processing, and
when the predetermined condition is not satisfied, not to execute the broken line addition processing.

20. A non-transitory computer readable storage medium storing a program that is executable by a computer of an information processing apparatus and supports a printer connected to the information processing apparatus, wherein
the program is capable of causing the computer to execute
acquisition processing of acquiring image data, and
output processing of outputting a print command for causing the printer to print an image based on the image data acquired in the acquisition processing, and
the program further causes the computer to execute
character detection processing of detecting character data representing a character from the image data acquired in the acquisition processing before executing the output processing and after executing the acquisition processing, and
broken line addition processing of adding a broken line to an edge of the character represented by the character data detected in the character detection processing, and
the broken line to be added in the broken line addition processing includes a plurality of line segments and a plurality of non-line segments between the line segments and, a ratio of the line segments to the non-line segments when a predetermined condition is satisfied is lower than that when the predetermined condition is not satisfied.
